(19) United States
(12) Patent Application Publication
(10) Pub. No.: US 2022/0198958 A1
(43) Pub. Date: Jun. 23, 2022

(54) SYSTEMS AND METHODS FOR SURGICAL TRAINING

(71) Applicant: INTUITIVE SURGICAL OPERATIONS, INC., Sunnyvale, CA (US)

(72) Inventors: Jay ROHDE, Chapel Hill, NC (US); May Quo-Mei LIU, Hillsborough, NC (US); Daniel S. OH, Yorba Linda, CA (US); Christopher GILLEN, San Jose, CA (US); Sascha RETAILLEAU, San Francisco, CA (US); Brian RULIFSON, Seattle, WA (US)

(73) Assignee: INTUITIVE SURGICAL OPERATIONS, INC., Sunnyvale, CA (US)

(21) Appl. No.: 17/457,929

(22) Filed: Dec. 7, 2021

Related U.S. Application Data
(60) Provisional application No. 63/126,862, filed on Dec. 17, 2020.

(51) Int. Cl. G09B 23/30; G09B 23/34

(52) U.S. Cl. CPC G09B 23/306; G09B 23/34

(57) ABSTRACT

A surgical training system may include a model base having at least one channel therein and opening outwardly to a top surface. A model insert may be removably coupled to the top surface of the model base. The model insert may include tissue for surgical training and a plurality of connectors coupled to the tissue and slidably received within the at least one channel.

### PRIORITY APPLICATION(S)

This application is based upon and claims priority to and the benefit of the filing date of U.S. provisional patent application Ser. No. 63/126,862 filed Dec. 17, 2020, the disclosure which is hereby incorporated by reference in its entirety.

### FIELD OF THE INVENTION

Aspects of the present disclosure are directed to surgical training systems and methods, and in particular to anatomical and non-anatomical models and methods for training surgical procedures and techniques.

### BACKGROUND OF THE INVENTION

Surgical procedures may be performed using open or general surgery, laparoscopic surgery, and/or robotically assisted surgery. To become qualified to perform surgical procedures, surgeons participate in comprehensive training to become proficient in the variety of tasks required to perform the procedures. Such tasks include inserting and directing surgical tools to anatomical features of interest such as tissue or organs, manipulating tissue, grasping, clamping, cutting, sealing, suturing, and stapling tissue, as well as other tasks. To gain proficiency, it is beneficial to allow surgeons to repeatedly practice these tasks for multiple different procedures. In addition, it can be beneficial to quantify training and performance of such tasks by surgeons, thereby enabling them to track progress and improve performance.

Various systems have been developed to provide surgical training. For example, training may be conducted on human cadavers. However, cadavers may be expensive and provide limited opportunities to train. In addition, a single cadaver may not allow the surgeon to repeatedly practice the same procedure. Surgical models have also been utilized for surgical training. However, such models may not be suitable for training minimally invasive procedures using laparoscopic or robotically assisted tools. In minimally invasive procedures, the surgical tools must be inserted into the body via natural orifices or small surgical incisions and then positioned near the anatomical features of interest. Current surgical models may not allow for a way to securely and repeatedly attach organ models to a containing structure representing a patient body wall in which the small incisions are to made. This may hinder the ability to configure the surgical models for repeated practice of the same procedure. In addition, current surgical models may not provide a variety of configurations in which organ models may be attached or positioned, thereby limiting how minimally invasive tools may be used for training. In addition, current surgical models may not have sufficient dissection planes to allow for proper or realistic tool access for training.

### SUMMARY OF THE INVENTION

Various embodiments of the present disclosure are summarized by the claims that follow the description. Other embodiments may be claimed at a later time.

A surgical training system may include a model base having at least one channel, a top surface, and an opposite bottom surface, wherein the at least one channel has an opening directed outwardly to the top surface of the model base. A model insert may be removably coupled to the channel of the model base. The model insert may comprise tissue for surgical training and a plurality of connectors coupled to the tissue and slidably received within the at least one channel.

The model base may comprise a lower layer and an upper layer coupled thereto. The upper layer may define a restriction for the at least one channel, and the restriction may prevent the model insert from being removed from the opening directed outwardly to the top surface of the model base. The at least one channel may have a serpentine shape. The plurality of connectors may comprise a plurality of hooks and a compressible elongate member received within the hooks.

The tissue for surgical training may comprise real tissue. The tissue for surgical training may comprise synthetic tissue. The model base may comprise a plurality of permanent magnets and configured to retain additional tissue for surgical training. At least one tube may be carried by the model base. At least one electrical conductor may be carried by the model base. At least one sensor may be carried by the model base. At least one force sensor may be carried by the model base.

Another aspect is directed to a surgical training method using a model base having at least one channel therein and opening outwardly to a top surface of the model base. The method includes coupling a model insert that may comprise tissue for surgical training and a plurality of connectors coupled to the tissue and slidably received within the at least one channel.

It is to be understood that both the foregoing general description and the following detailed description are exemplary and explanatory in nature and are intended to provide an understanding of the present disclosure without limiting the scope of the present disclosure. And so, additional aspects, features, and advantages of the present disclosure will be apparent to one skilled in the art from the following detailed description.

### BRIEF DESCRIPTIONS OF THE DRAWINGS

Other objects, features and advantages of the present invention will become apparent from the detailed description of the invention which follows, when considered in light of the accompanying drawings in which:

FIG. 1A is a simplified diagram of a surgical training system according to some embodiments;

FIG. 1B depicts a cross section of a model insert connected to a model base according to some embodiments;

FIGS. 1C-1D are simplified diagrams of model inserts according to some embodiments;

FIGS. 1E-1F are simplified diagrams of a model insert and a model base according to some embodiments;

FIGS. 2A-2B are simplified diagrams of model inserts according to some embodiments;

FIG. 3 is a simplified diagram of a surgical training system according to some embodiments;

FIG. 4 is a simplified diagram of a portion of the surgical training system of FIG. 3;

FIGS. 5A-5B are simplified diagrams of a surgical training system according to some embodiments;

FIGS. 6A-6C illustrate a surgical training system according to some embodiments;

FIGS. 6D-6E illustrate a surgical training system according to some embodiments;

FIG. 7 illustrates a surgical training system according to some embodiments;

FIG. 8 is a flowchart illustrating a method for operating a surgical training system according to some embodiments;

FIG. 9 is an isometric view of a model base having a lower layer and upper layer coupled thereto according to another embodiment;

FIG. 10 is an exploded isometric view of the model base of FIG. 9 showing the lower layer and upper layer;

FIG. 11 is a front elevation view of the model base looking in the direction of arrow 11 in FIG. 9;

FIG. 12 is a partial, cut-away sectional view of the model base of FIG. 9;

FIG. 13 is an isometric view of the model base of FIG. 9 received within an abdominal holder;

FIG. 14 is a perspective view of a manipulator system according to an example embodiment of the disclosure; and

FIG. 15 is a partial schematic view of an embodiment of a manipulator system having a manipulator armed with two instruments in an installed position according to the present disclosure.

### DETAILED DESCRIPTION

The present description is made with reference to the accompanying drawings, in which exemplary embodiments are shown. However, many different embodiments may be used, and thus, the description should not be construed as limited to the particular embodiments set forth herein. Rather, these embodiments are provided so that this disclosure will be thorough and complete. Like numbers refer to like elements throughout, and prime notation is used to indicate similar elements in different embodiments.

In addition, the singular forms “a”, “an”, and “the” are intended to include the plural forms as well, unless the context indicates otherwise. And the terms “comprises,” “comprising,” “includes,” “has,” and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components. The auxiliary verbs “can” and “may” likewise imply that a feature, step, operation, element, or component is optional.

Elements described in detail with reference to one embodiment, implementation, or application optionally may be included, whenever practical, in other embodiments, implementations, or applications in which they are not specifically shown or described. For example, if an element is described in detail with reference to one embodiment and is not described with reference to a second embodiment, the element may nevertheless be claimed as included in the second embodiment. Thus, to avoid unnecessary repetition in the following description, one or more elements shown and described in association with one embodiment, implementation, or application may be incorporated into other embodiments, implementations, or aspects unless specifically described otherwise, unless the one or more elements would make an embodiment or implementation non-functional, or unless two or more of the elements provide conflicting functions. In some instances, well-known methods, procedures, components, and circuits have not been described in detail so as not to unnecessarily obscure aspects of the embodiments.

The present application discloses systems and methods used for surgical procedure training. Various disclosed implementations of anatomical and non-anatomical systems provide a platform for surgeons to conduct training using open surgery or minimally invasive surgical techniques. The surgical training systems described herein include model inserts that are removably coupled to a model base. The model inserts may be quickly and easily removed and replaced to allow surgeons to repeatedly practice the same procedure or skills to improve proficiency.

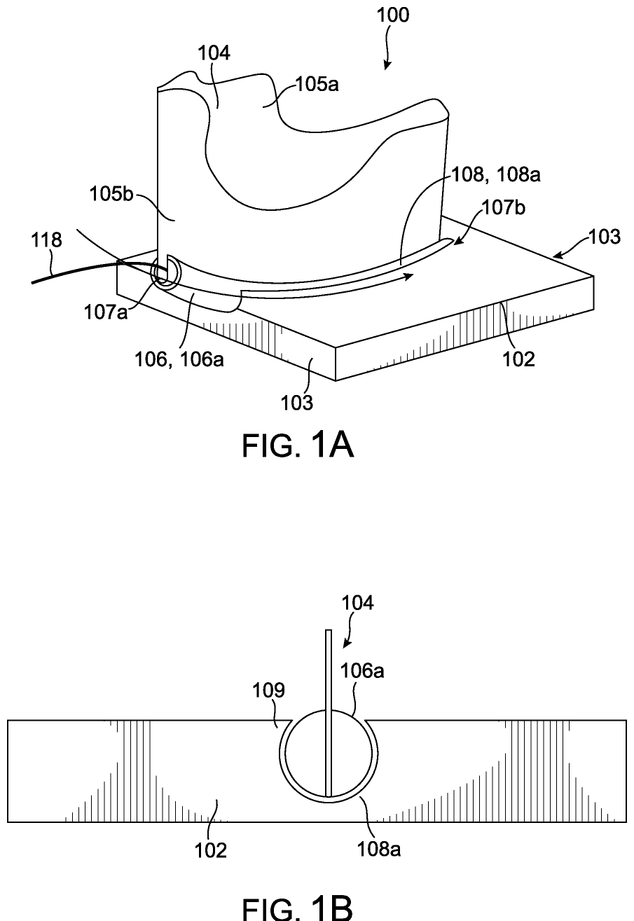

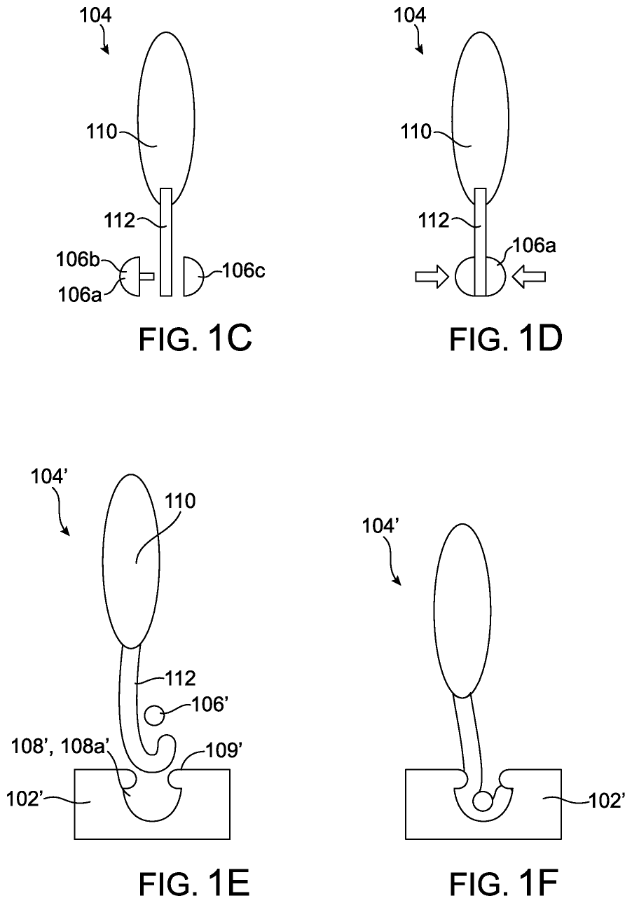

FIG. 1A is a simplified diagram of a surgical training system 100 according to some embodiments. The surgical training system 100 includes a model base 102 and one or more model inserts 104 removably coupled to the model base 102. The model base 102 may be an anatomical or non-anatomical model configured to hold the model inserts 104 in place. In some embodiments, the model base 102 may be shaped as a three-dimensional anatomical model of a portion of a human or animal body, and may be shaped as any part of the body. For example, the model base 102 may be shaped as a torso, an abdominal section, a head, an oral cavity, a pelvis, a chest cavity, or any other body portion. In some embodiments, the model base 102 may be shaped as a non-anatomical model, and may have a flat, planar shape (e.g., in the shape of a rectangle, circle, square, or other regular or irregular shape), or may have a three dimensional shape (e.g., with one or more cavities for placement of the model inserts 104 therein). Optionally, in some embodiments, the material of the model base 102 may be selected to have the look, feel, and/or properties of real human or animal tissue. In some embodiments, the model base 102 may be made out of metal, polymeric materials such as plastic, elastomers, rubber or silicone, wood, or a combination of such materials. However, the model base 102 is not limited thereto or thereby and may be made of any other suitable material sufficient to couple to and support the model inserts 104.

The model insert 104 may be an anatomical or non-anatomical model configured to be removably coupled to the model base 102. In some embodiments, the model insert 104 may be a three-dimensional anatomical model of tissue or an organ. For example, the model insert 104 may be shaped as a heart, liver, lung, kidney, intestines, or any other tissue or organ of a human or animal body. In some embodiments, the surgical training system 100 may include a plurality of inserts 104, such that multiple organs are included in the surgical training system 100. For example, the model base 102 may be shaped as an abdominal model and the model inserts 104 may be shaped as one or more of the large intestines, small intestines, kidneys, liver, pancreas, or other organs. In some embodiments, a single model insert 104 may be shaped an individual organ or shaped as multiple organs. Further, in some embodiments, a single model insert 104 may be shaped as a portion of an organ, such that multiple model inserts 104 together form the shape of an organ. Referring to FIG. 1A, in some embodiments, optionally, the model insert 104 may include an organ portion 105a shaped as a human or animal organ and a connective tissue portion 105b shaped as connective tissue that supports and connects the organ. The connective tissue portion 105b may be positioned between the organ portion 105a and engagement features 106 of the model insert 104 (described further below) that couple to the model base 102. The material of the model insert 104 may be selected to have the look, feel, and/or properties of real human or animal tissue. The model inserts 104 may be made out of real tissue harvested from deceased humans or animals, simulated tissue made of natural and/or synthetic tissue-like materials containing organic or non-organic materials, or any combination thereof. For example, in some embodiments, the material of the model insert 104 may be selected from the group of real tissue and simulated tissue. The simulated tissue may include silicone based materials, hydrogels, plant based materials, biomaterials, and/or materials derived from tissue engineering or regenerative medicine processes, and the simulated tissue may be formed into tissue-like formations. The simulated tissue may be designed to simulate the look, feel, and/or properties of real human or animal tissue. In some embodiments where the model inserts 104 include real human or animal tissue, the inserts 104 may include muscle tissue (e.g., skeletal muscle tissue, cardiac muscle tissue, and/or smooth muscle tissue), connective tissue, epithelial tissue, nervous tissue, or a combination thereof. Further, in some embodiments where the model inserts 104 include simulated tissue made of tissue-like materials, the tissue-like materials may be designed to simulate muscle tissue, connective tissue, epithelial tissue, nervous tissue, or a combination thereof.

The model inserts 104 may be consumable components that are designed to be replaced after being used in surgical training. The model inserts 104 may be replaced during a training session or between training sessions. As described above, the model inserts 104 are configured to be removably coupled with the model base 102. The removable coupling allows for the model inserts 104 to be quickly, easily, and accurately positioned with respect to the model base 102 at prearranged attachment points. This enables proper tissue manipulation and retraction during surgical training, and particularly for training on minimally invasive procedures involving laparoscopic and robotically assisted surgery. In addition, the removable coupling allows surgeons to repeatedly practice the same procedure or skills to improve proficiency. For example, surgeons may conduct training using one or more of the model inserts 104 coupled to the model base 102, and then quickly remove and replace the used model inserts 104 with unused model inserts 104 to continue training. The removable coupling also enables surgeons to vary the model inserts 104 used, which can allow surgeons to practice different skills or otherwise vary the training. For example, the model inserts 104 may include a variable element that is different between similar model inserts 104, such as having a portion simulating a tumor that is located at a different position and having a different size in different model inserts 104.

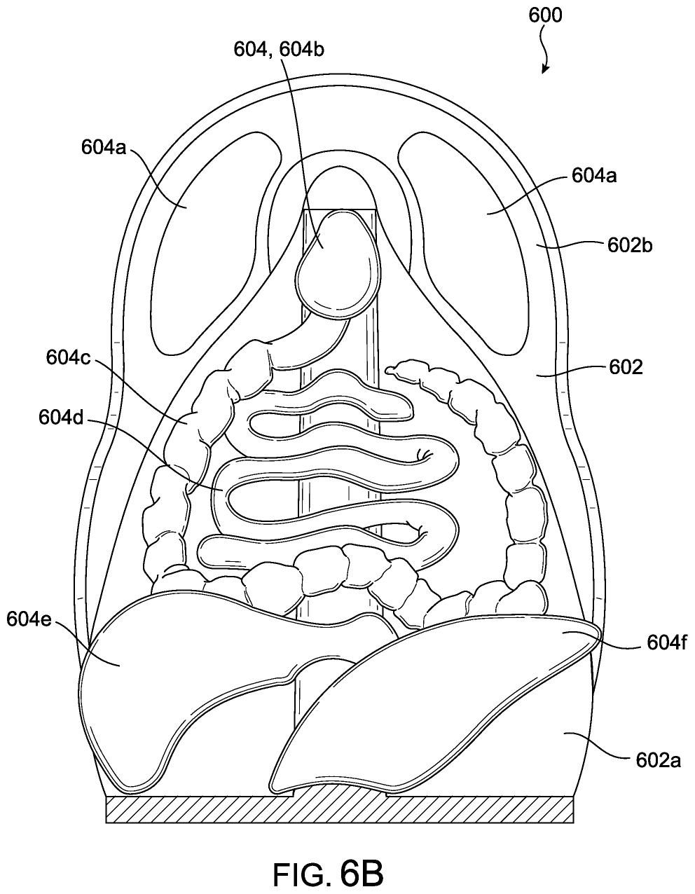

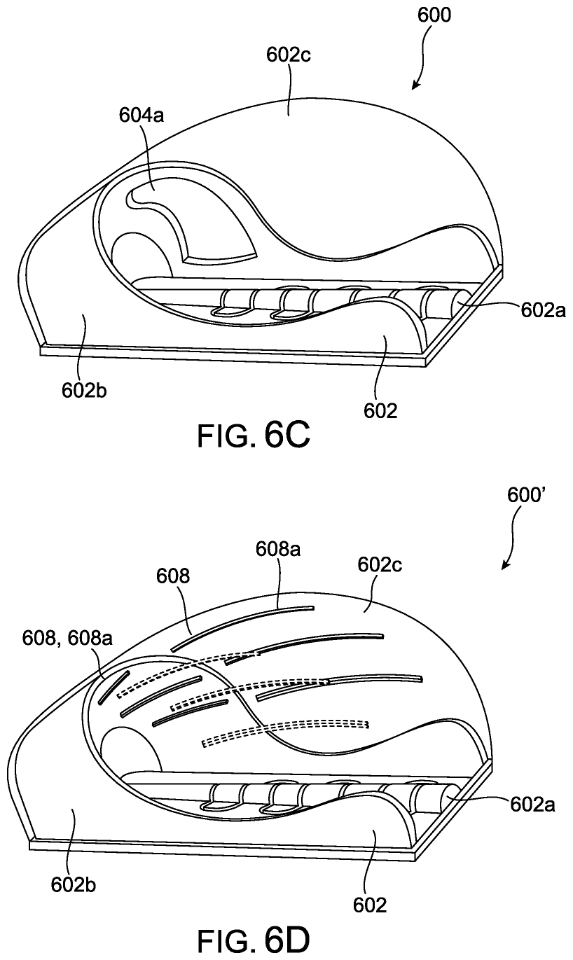

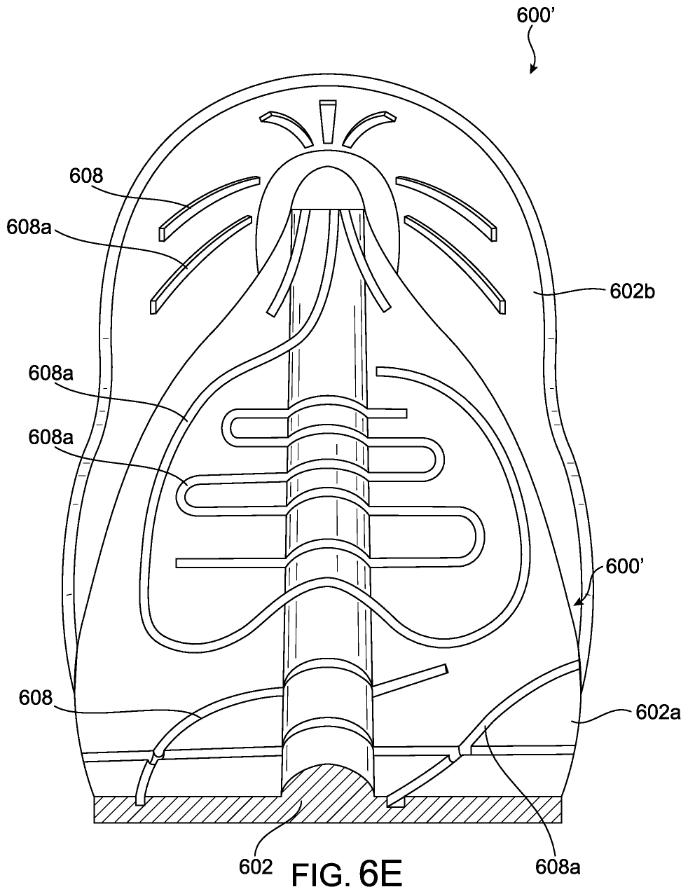

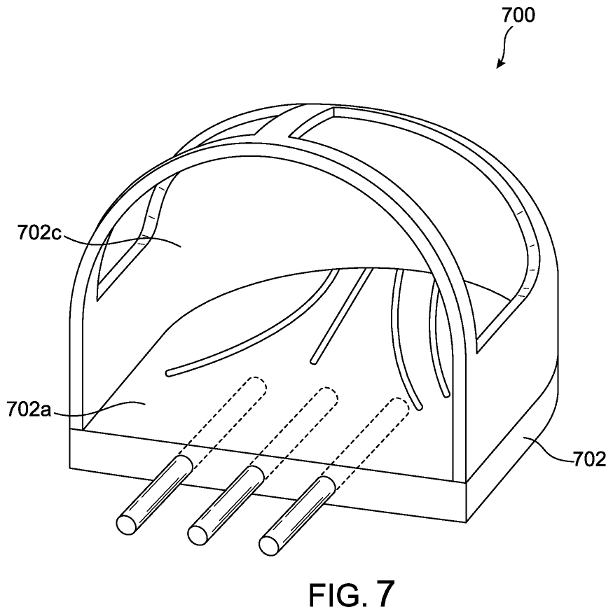

To couple the model inserts 104 to the model base 102, the model inserts 104 include engagement features 106 that are configured to couple to complimentary engagement features 108 of the model base 102. In the embodiments shown in FIG. 1A, the engagement features 106 of the model insert 104 are in the form of a carriage 106a, and the engagement features 108 of the model base 102 are in the form of a track 108a. The carriage 106a and the track 108a have complimentary shapes to allow for easy alignment and connection. In some embodiments, the track 108a may have the shape of a recess or slot (e.g., an elongate slot) extending into a surface in the model base 102. In other embodiments, the track 108a may have the shape of a rail extending outwardly from a surface of the model base 102. The track 108a provides an attachment point for the model insert 104, and thereby provides precise positioning of the model inserts 104 relative to the model base 102. The track 108a may have an elongate shape positioned in or on the surface of the model base 102 at regions corresponding to anatomical features of interest, for example, at regions where it is desired to include tissue or organs that may be manipulated during surgical training. Multiple tracks 108a may be provided at the model base 102, including tracks 108a at one or more lower portions, side portions, and/or upper portions of the model base 102, as described in further detail below (see, e.g., FIGS. 6A-6E). In various embodiments, the tracks 108a may have straight, curved, or serpentine shapes, and different tracks 108a may have different shapes and different lengths (e.g., an intestine model insert may be used with a longer track than a kidney model insert). In some embodiments, the tracks 108a and the carriage 106a may each be keyed to permit coupling to each other only in one or more preferred orientations. In addition, in some embodiments, certain tracks 108a may have cross-sectional shapes and/or sizes to permit selective coupling only to certain model inserts 104. For example, a first model insert may have a carriage with a first cross-sectional shape and/or size, and a second model insert may have a carriage with a second cross-sectional shape and/or size that is different than the first model insert. A first track of a model base may have a cross sectional shape and/or size that permits coupling to the carriage of the first model insert, but prohibits coupling to the carriage of the second model insert. Likewise, a second track of the model base may have a cross sectional shape and/or size that permits coupling to the carriage of a second model insert, but prohibits coupling to the carriage of the first model insert.

In some embodiments, the model inserts 104 may be connected to the model base 102 by sliding the carriage 106a into engagement with the track 108a of the model base 102. The carriage 106a may be rigidly affixed to a portion of the model insert 104, such as an end portion of the model insert 104. When the carriage 106a slides along the track 108a, either a portion or all of the model insert 104 will move relative to the model base 102. An operator may connect the model insert 104 with the model base 102 by grabbing and sliding any preferred portion of the model insert 104. The carriage 106a may have any shape suitable for permitting sliding engagement of the carriage 106a along the track 108a. The cross-section of the carriage 106a may be in one of a variety of different possible shapes to permit sliding engagement, for example, a square, rectangle, triangle, circle or rounded shape, a polygon, a spline, a star shape, or an irregular shape. In some embodiments where the track 108a is a recess or slot extending into a surface in the model base 102, the track 108a and the carriage 106a may have complimentary shapes that prevent or hinder the carriage 106a from being inadvertently removed from the track 108a and the model base 102 (e.g., the carriage 106a may be hindered from being vertically lifted from the track 108a). For example, FIG. 1B depicts a cross-section of a model insert 104 connected to a model base 102 according to some embodiments. In the embodiment of FIG. 1B, the model insert 104 has a carriage 106a, which is connected to a track 108a of the model base 102. The cross-sections of the carriage 106a and the track 108a of FIG. 1B have complimentary rounded shapes, with the carriage 106a having a cylindrical shape and a circular or round cross-section, and the track having an open slot extending into the model base 102 with a complementary circular or rounded cross-section. As shown in FIG. 1B, the track 108a has a reduced width 109 at an upper open portion of the track 108a. The reduced width 109 is smaller than the maximum width of the carriage 106a, thereby hindering or preventing inadvertent vertical removal. In embodiments where the track is a rail extending outwardly from a surface of the model base 102, the carriage 106a may have a slot or recess for receiving the rail. The slot or recess may have a cross-sectional shape to hinder or prevent vertical removal of the carriage 106a from the model base 102 (e.g., the slot or recess of the carriage 106a may have a tapering cross-sectional shape with a reduced width at an open end portion of the slot or recess). In some embodiments, the carriage 106a and/or the track 108b may have additional or alternative retention features to hinder or prevent vertical removal, such as deployable anchors or magnets. In some embodiments, the model insert 104 may have a single carriage 106a, which may extend along a portion or all of a length of the model insert 104. In other embodiments, the model insert 104 may have multiple carriages 106a to facilitate sliding engagement of the carriage 106a with the track 108a. The multiple carriages 106a may be spaced apart from each other.

As shown in FIG. 1A, the track 108a has a first end 107a and an opposite second end 107b. In various embodiments, each track end 107a, 107b may extend to an edge of the model base 102 such that the respective track end 107a, 107b is open with respect to the edge, or the respective track end 107a, 107b may be spaced apart from an edge of the model base such that the respective track end 107a, 107b is closed with respect to the edge. For example, in some embodiments, the track 108a may have a first open end 107a extending to an edge 103 of the model base 102, and a second closed end 107b that is spaced apart from an edge 105 of the model base 102. In some embodiments, the open end 107a may permit inserting the carriage 106a into engagement with the track 108a, and the closed end 107b may act as a stop indicating full engagement of the model insert 104 and the model base 102. The carriage 106a may be inserted into the open end 107a of the track 108a, and then the carriage 106a may be slid until it reaches the closed end 107b of the track 108a, indicating that the carriage 106a is fully seated. Thereby, the track 108a may facilitate easy engagement of the model insert 104 with the model base 102. To remove the model insert 104, this procedure may be reversed. Optionally, the track 108a may additionally have one or more locking elements to prevent inadvertent removal of the carriage 106a once connected. For example, the track 108a may have a resilient protrusion at the open end 107a that deflects when the carriage 106a is inserted and returns back to its original position when the carriage 106a is fully seated. The protrusion may be manually deflected to remove the model insert 104.

In some embodiments, the track 108a may have two open ends 107a, 107b, each extending to an edge 103, 105 of the model base 102. The two open ends 107a, 107b may permit the carriage 106a and the model insert 104 to be inserted into either end 107a, 107b of the track 108a. Optionally, one or both of the ends 107a, 107b may have locking elements to prevent inadvertent removal of the carriage 106a once connected, such as resilient protrusions as described above.

In some embodiments, the track 108a may have two closed ends 107a, 107b, where each end is spaced apart from an edge of the model base 102. In such embodiments, one or both of the track ends 107a, 107b may have an enlarged open portion to permit engagement of the carriage 106a with the track 108a.

As described above with respect to FIG. 1A, the model insert 104 may have the carriage 106a and the model base 102 may have the track 108a. In alternate embodiments, the model base 102 may have the carriage 106a and the model insert 104 may have the track 108a. Thereby, in some embodiments, at least one of the model base 102 and the model inserts 104 has a track 108a and the other of the model base 102 and the model inserts 104 has a carriage 106a. In further alternate embodiments, the model base 102 may have both a track 108a (or multiple tracks 108a) and a carriage 106a (or multiple carriages 106a) to mate with complementary features of the model inserts 104.

FIGS. 1C-1D are simplified diagrams of a model insert 104 according to some embodiments. In FIG. 1C, the model insert 104 is depicted with the carriage 106a removed from the model insert 104, and in FIG. 1D, the model insert 104 is depicted with the carriage 106a attached to the model insert 104. As shown in FIGS. 1C-1D, the model insert 104 may include a main portion 110, a connector 112, and the carriage 106a. The main portion 110 is the portion of the model insert 104 that is configured to be manipulated by surgical instruments during training, and may include at least one selected from the group of real tissue and simulated tissue (e.g., the main portion may include real tissue and/or simulated tissue), described above. In some embodiments, optionally, the main portion 110 of the model insert 104 may include an organ portion 105a and a connective tissue portion 105b (see FIG. 1A). The connector 112 is used to connect the carriage 106a to the main portion 110. The carriage 106a may be connected to an end region of the model insert 104, and may be located opposite to the main portion 110. In some embodiments, when the model insert 104 is coupled to the model base 102, the main portion 110 will be substantially flush with the surface of the model base 102. The carriage 106a may be connected to the connector 112 and the connector 112 may be connected to the main portion 110 by any suitable structure for engagement, such as mechanical fasteners, screws, snap fits, adhesive, and the like. In some embodiments, the connector 112 may be continuous with the main portion 110 such that they are a single piece of material. Further, optionally, in some embodiments, an end region of the main portion 110 may have a connection region (e.g., through holes) for coupling to the carriage 106a such that a separate connector 112 is not used. In some embodiments, optionally, the carriage 106a may have a two-piece construction that snaps together. For example, referring to FIG. 1C, the carriage 106a may have a male portion 106b having one or more protrusions and a female portion 106c having one or more receptacles configured to receive the protrusions of the male portion. The two-piece construction of the carriage 106a may sandwich the connector 112 between the two pieces of the carriage 106a (see FIG. 1D). In various model inserts 104, the connector 112 for one model insert 104 may have a different length than the connector 112 for another model insert 104. This may allow the main portions 110 for different model inserts 104 to be located at different heights from each other when installed, thereby forming a layered appearance. This may be particularly applicable for model inserts 104 that are located near each other, and may be used for practicing retraction as described in more detail below.

FIGS. 1E-1F are simplified diagrams of a model insert 104′ and a model base 102′ according to some embodiments. FIG. 1E depicts the model insert 104′ removed from the model base 102′, and FIG. 1F depicts the model insert 104′ coupled to the model base 102.′ The model base 102′ and model insert 104′ differ from the previous embodiments in that the model insert 104′ may be pressed into engagement with the model base 102′ (e.g., via vertical engagement relative to the orientation shown in FIG. 1E). In FIGS. 1E-1F, the model base 102′ includes engagement features 108′ in the form of a track 108a′. The model insert 104′ includes a main portion 110, a connector 112′, and a retention member 106′. The main portion 110 may be the same or similar as in the previous embodiments. The connector 112′ and the retention member 106a′ may be used to press the model insert 104′ into engagement with a track 108a′ of the model base 102′. In some embodiments, the retention member 106′ may include a flexible cord that extends along an axial length of the model insert 104′. The connector 112′ may be wrapped around the flexible cord of the retention member 106′, and the connector 112′ and the retention member 106′ may together be pressed into engagement with the track 108a′. In some embodiments, when the model insert 104′ is engaged with the track 108a′, the connector 112′ and the retention member 106′ may form an interference fit with the track 108a′ (e.g., a press fit or a friction fit). In some embodiments, the connector 112′ and/or the retention member 106′ may be compressed to fit within the opening of the track 108a′, and the connector 112′ and/or the retention member 106′ may expand once inserted into the track 108a′. For example, the connector 112′ and/or the retention member 106′ may be made of a resilient material (e.g., rubber) to allow for compression for insertion into the track 108a′ and expansion once inserted. As another example, the connector 112′ and/or the retention member 106a′ may include a compressible spring that compresses for insertion into the track 108a′ and expands once inserted. In some embodiments, the track 108a′ may have a reduced width 109′ at an upper open portion of the track 108a′. The reduced width 109′ of the track 108a′ is smaller than the maximum width of the portion of the model insert 104′ engaged with the track 108a′, thereby hindering or preventing inadvertent vertical removal of the model insert 104′. It should be appreciated that the model base 102′ may be configured for simultaneous use with the model inserts 104 described above with respect to FIGS. 1A-1D and the model inserts 104′ described with reference to FIGS. 1E-1F. To that end, the model base 102′ may include one or more engagement features 108 described above for slidably coupling the model insert 104 with the engagement features 108, and the model base 102′ may include one or more engagement features 108′ for pressing the model insert 104a′ into engagement with the engagement features 108′ of the model base 102′.

In some embodiments, optionally, the model inserts 104 may have movable portions that may be retracted so that a surgeon can practice retraction to manipulate and practice skills on structures underneath the retracted portions that are otherwise difficult to access. By way of example, in some embodiments, adjacent model inserts 104, 104′ may be positioned such that one model insert 104, 104′ partially or completely obstructs access to another model insert 104, 104′. The obstructing model insert 104, 104′ may optionally have a larger main portion 110 and/or a longer connector 112 than the model insert 104, 104′ that is obstructed. The main portion 110 of the obstructing model insert 104, 104′ may then be movable relative to the obstructed model insert 104, 104′ to allow access to the obstructed model insert 104, 104′. Likewise, one or more portions of a main portion 110 of one model insert 104, 104′ may be movable relative to another portion of the same model insert 104, 104′. In some embodiments, portions of a main portion 110 of a model insert 104 may be flexible or bendable to permit movement of the flexible or bendable portions, which then may be moved relative to other portions of the same model insert 104, 104′ and/or to permit movement relative to other model inserts 104, 104′. Further, in some embodiments, an entirety of a main portion 110 of a model insert 104, 104′ may be flexible or bendable to permit movement. Further still, main portions 110 of different model inserts 104, 104′ and/or different portions of a single model insert 104, 104′ may have differing amounts of flexibility or stiffness. For example, a first portion of a main portion 110 that is closer to the model base 102 may have greater stiffness than a second portion of the main portion 110 that is positioned further away from the model base 102. This may permit the first portion of the main portion 110 to provide rigidity for supporting the model insert 104, 104′ while the second portion of the main portion 110 is retractable. Additionally or alternatively, the main portions 110 may have hinged or folded portions that are movable relative to other portions of the same model insert 104, 104′ or moveable relative to different model inserts 104, 104′. For example, a second portion of a main portion 110 that is positioned further away from the model base 102 may be hinged or foldable relative to a first portion of the main portion 110 that is closer to the model base 102.

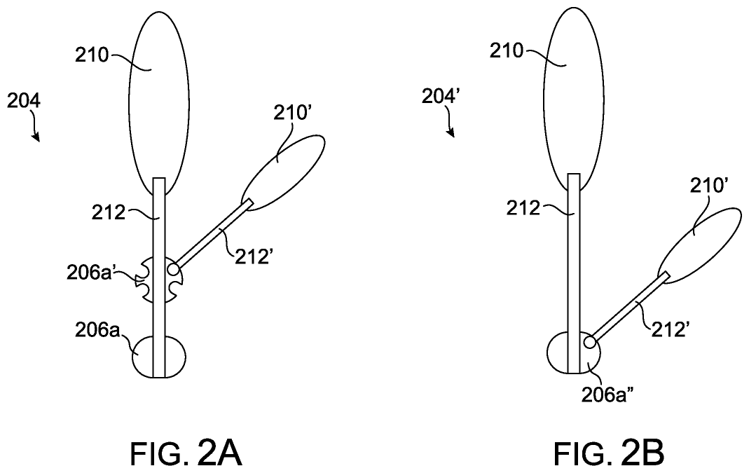

FIG. 2A is a simplified diagram of a model insert 204 according to some embodiments and FIG. 2B is a simplified diagram of another model insert 204′ according to some embodiments. The model inserts 204, 204′ in FIGS. 2A-2B depict examples of multiple main portions 210, 210′ being connected to a single model insert 204 or 204′ via multiple connectors 212, 212′. In FIG. 2A, the model insert 204 includes two main portions 210, 210′ connected to two different carriages, a first carriage 206a and a second carriage 206a′. The first main portion 210 is connected to the first carriage 206a by a first connector 212. The second main portion 210′ is connected to the second carriage 206a′ by a second connector 212′. The second carriage 206a′ is also connected to the first connector 212 such that both main portions 210, 210′ are part of a single model insert 204. The first carriage 206a may be located at an end portion of the connector 212. The second carriage 206a′ is interlocked with the connector 212 and may be located at an intermediate portion of the connector 212, the intermediate portion located between the first carriage 206a and the first main portion 210. In FIG. 2B, the model insert 204′ also includes two main portions 210, 210′, but which are each connected to a common carriage 206a″. The common carriage 206a″ is connected to the first main portion 210 by a first connector 212, and the carriage 206a″ is also connected to the second main portion 210′ by a second connector 212′. It should be appreciated that the number of main portions, carriages, and connectors for a single model insert is not limited to the examples in FIGS. 2A-2B. While the model inserts 204, 204′ in FIGS. 2A-2B include two main portions 210, 210′ and two connectors 212, 212′, the model inserts 204, 204′ are not limited thereto or thereby, and in various embodiments, the model inserts 204, 204′ may include more than two main portions and more than two connectors, such as three, four, or five main portions and connectors, etc. Further, any of the carriages 206a, 206a′, 206a″ may be connected to one connector and one main portion, or any of the carriages 206a, 206a′ 206a″ may be connected to multiple connectors and associated main portions (e.g., two, three, four or more connectors and associated main portions). In addition, a single model insert may have one carriage (e.g., as in FIG. 2B), two carriages (e.g., as in FIG. 2A), or more than two carriages (e.g., three, four or more carriages). In addition, in some embodiments, multiple main portions 210, 210′ of a single model insert may be touching despite being connected to different connectors 212, 212′. Further, it should be appreciated that the model inserts 104′ described in FIGS. 1E-1F may similarly have multiple main portions. Also, as shown in FIG. 2A, the connectors 212, 212′ may have different lengths and may be located at different angles from each other, such that the main portions 210, 210′ may be located at different heights from each other when installed, thereby forming a layered appearance, and which optionally may be used for practicing retraction. In addition, the position of the carriage 206a′ relative to the connector 212 may be moved to modify the height of the main portion 210′ with respect to the main portion 210. Further, it should be appreciated that any of the model inserts 104, 204, 204′ may be used in any of the surgical training systems described herein.

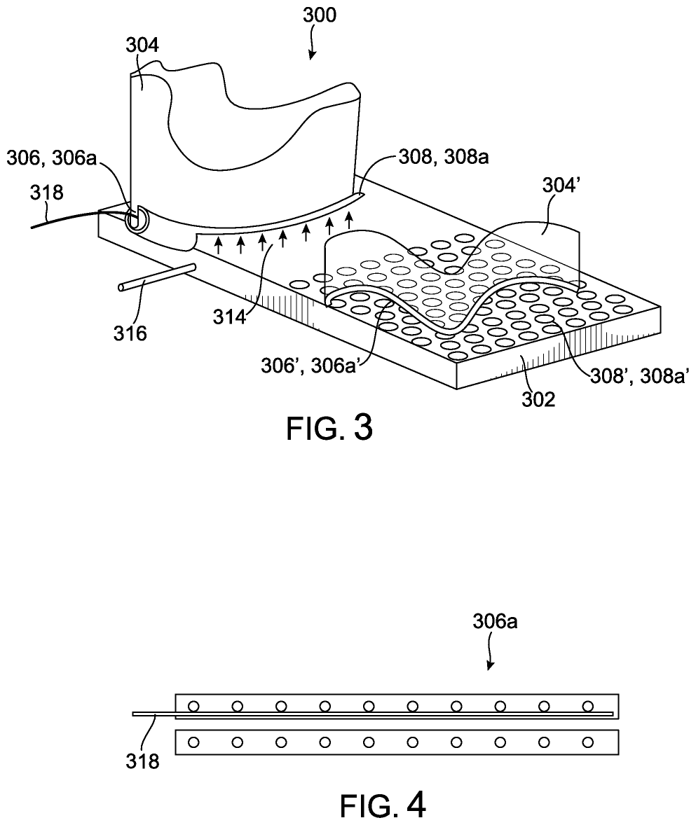

FIG. 3 is a simplified diagram of a surgical training system 300 according to some embodiments. The surgical training system 300 includes a model base 302 and model inserts 304, 304′ removably coupled to the model base 302. In the embodiments in FIG. 3, the model base 302 has engagement features 308 in the form of a track 308a, and the model insert 304 has engagement features 306 in the form of a carriage 306a. However, in alternate embodiments, the model base 302 may have engagement features in the form of a carriage and the model insert 304 may have engagement features in the form of a track. The model insert 304 may be similar to the model insert 104, but optionally includes one or more sensors 314 (e.g., one, two, three, or more sensors) for detecting forces or torques during training and providing feedback information to the user. The sensors 314 may be embedded in the model inserts 304, 304′ and/or the base 302. When embedded in a model insert, the sensors 314 may be embedded in any of the main portions, carriages, and connectors of the model insert. The sensors 314 may be used to indicate to a user the amount of force or torque acting upon the model insert 304 and/or the model base 302 by the user's manipulation of tools during training. The sensors 314 may include force sensors, torque sensors, pressure sensors, temperature sensors, and the like. For example, the sensors 314 may include strain gauges, pressure transducers, load cells, piezoelectric sensors, force sensitive resistors, capacitive sensors, thermocouples, RTDs, thermistors, and the like. The sensors 314 may be coupled to a controller via one or more electrical leads 316 to provide power to the sensors 314 and to output sensor data to a controller, the sensor data including forces, torques, and/or pressures. The controller may provide the sensor data to the user (e.g., visualization via a display, as a print out, and/or an audio signal) during and/or after a surgical training session. In some embodiments, sensor data output from the sensors 314 (e.g., forces and torques applied to the surgical training system 300) may be used in connection with a control system for computer controlled instruments, such as in medical robotic systems. The sensor data may be used by the control system to control the computer controlled instruments. For example, the sensor data output from the sensors 314 may detect an applied force that exceeds a first predetermined threshold, which may be an indication of excessive forces. The sensor data may be used as a control signal for the control system to cause the robotic system to stop or reduce motion of the computer controlled instruments and/or stop or reduce motion of master user controllers that are used as inputs to apply forces to the instruments. In some embodiments, detection of an applied force that exceeds the first predetermined threshold may be used by the control system to apply resistance to the instrument and/or the master user controllers, wherein the resistance is proportional to the amount of additional motion that continues to increase the applied force. In addition or alternatively, the sensor data may be output as a warning to the user of excessive forces (e.g., visualization via a display, as a print out, and/or an audio signal). In another example, the sensor data output from the sensors 314 may detect an applied force that is less than a second predetermined threshold, which may be an indication of an insufficient force being applied to the tissue to manipulate the tissue (such as poor retraction). The second predetermined threshold for insufficient force may be set to a value that is less than the first predetermined threshold for excessive force. The sensor data may be output as a warning to the user of insufficient forces (e.g., via a display, as a print out, and/or an audio signal). In addition or alternatively, in some embodiments, detection of an applied force that is less than the second predetermined threshold may be used by the control system to apply force or resistance to the instrument and/or the master user controllers in the direction the user is applying forces (e.g., to aid the user and provide additional forces in the direction of the user's tissue manipulation).

Further referring to FIG. 3, the model insert 304′ may be similar to the model insert 104, 304, but the model insert 304′ is used in connection with different engagement features 306′, 308′. In FIG. 3, the model base 302 includes engagement features 308′ that are in the form of a magnetic surface 308a′. The magnetic surface may have a plurality of magnets arranged at desired locations suitable for connecting the model insert 304′. The model insert 304′ includes engagement features 306′ in the form of a magnetic carriage 306a′. The magnetic carriage 306a′ may be located at an end portion of the model insert 304′. The magnetic surface 308a′ of the model base 302 and the magnetic carriage 306a′ of the model insert 304′ may allow for freeform connection of the model insert 304′. In some embodiments, the magnetic surface 308a′ may be located over a surface area that is larger than the model insert 304′ to allow the model insert 304′ to be installed in a plurality of different poses or orientations relative to the model base 302. In other embodiments, the magnetic surface may have a smaller surface area or the same surface area as the model insert 304′, which may provide a specific positioning or orientation for coupling the model insert 304′ to the model base 302.

With reference to FIGS. 1A, 3, and 4, the model inserts 104, 304, 304′ may be manipulated using energy instruments that apply electrical energy (e.g., electrocautery instruments). The energy instruments may be used to apply electrical current to the main portions of the model inserts 104, 304, 304′. In various embodiments, bipolar energy instruments and/or monopolar energy instruments may be used with the model inserts. Optionally, to facilitate use with monopolar energy instruments, the model inserts 104, 304, 304′ and/or the model base 102, 302 may include one or more grounding wires 118, 318 as an electrical current return path (e.g., one, two, three or more grounding wires may be present). When used with monopolar energy instruments, the applied electrical current will pass from one or more electrodes of the monopolar energy instrument to the model inserts 104, 304, 304′, and electrical current will return back to an electrical current source (e.g., an electrogenerator) via the one or more grounding wires 118, 318. In some embodiments, the one or more grounding wires 118, 318 may be integrated into the engagement features 106, 108, 306, 308, 306′, 308′. For example, referring to FIG. 1A, the one or more grounding wires 118 may be integrated into the track 108a and/or the carriage 106a.

As another example, FIG. 4 is a simplified diagram of a portion of the surgical training system of FIG. 3, depicting a carriage 306a having an integrated grounding wire 318. The carriage 306a is part of the model insert 304 (see FIG. 3) and the carriage 306a is configured to be inserted into the track 308a of the model base 302. By integrating the grounding wire 318 with the model insert 304, the model insert 304 may be selectively coupled to the model base 302 while also grounding the model insert 304 for use with monopolar energy instruments. This may allow the model insert 304 to be placed in a variety of positions or configurations with respect to the model base 302 while maintaining grounding of the model insert 304. In the embodiment of FIG. 4, the carriage 306a has a two-piece construction, and the grounding wire 318 is embedded in one of the pieces of the carriage 306a. The model insert 304 is configured to be sandwiched between the two pieces of the carriage 306a. In some embodiments, optionally, the two-piece construction of the carriage 306a may have a male portion having one or more protrusions and a female portion having one or more receptacles configured to receive the protrusions of the male portion. In such embodiments, grounding wires 318 may be positioned in either the male portion or the female portion or in both portions. It should be appreciated that the grounding wires 118, 318 may be used in connection with any of the surgical training systems and model inserts described herein.

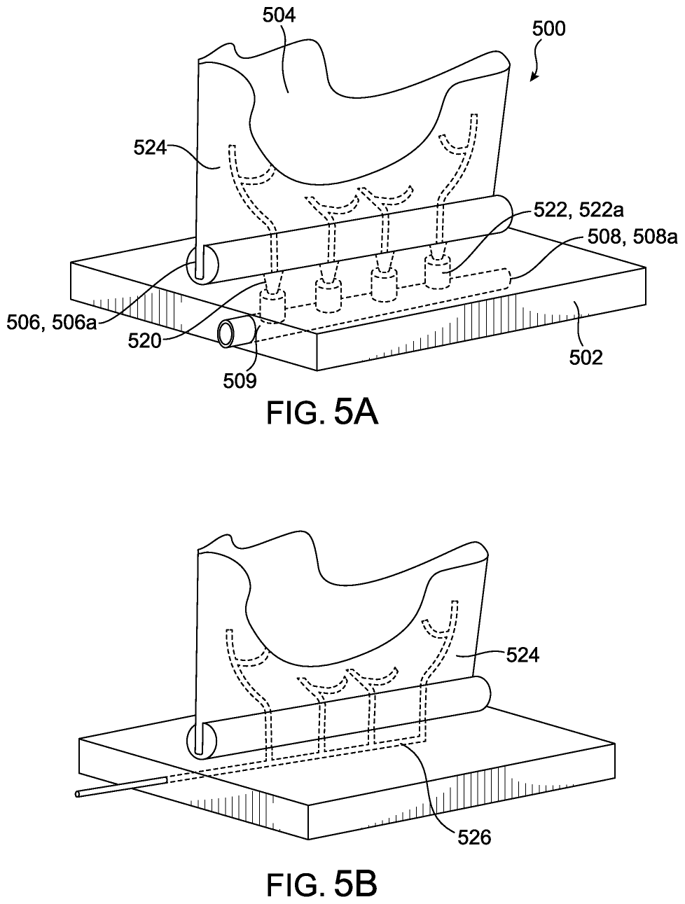

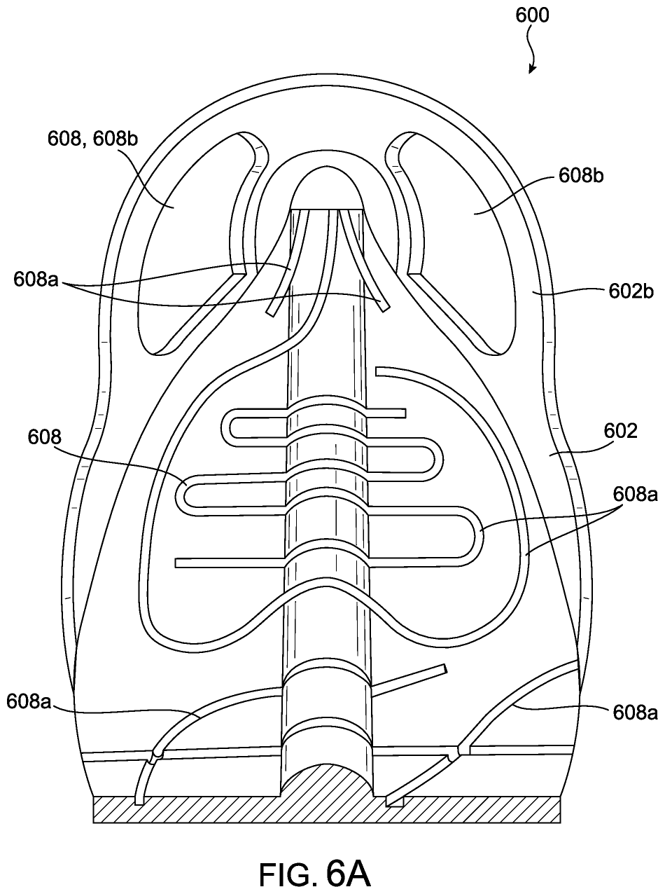

FIGS. 5A-5B are simplified diagrams of a surgical training system 500 according to some embodiments. The surgical training system 500 includes a model base 502 and one or more model inserts 504 removably coupled to the model base 502. In the embodiments shown in FIG. 5A, the engagement features 506 of the model insert 504 and the engagement features 508 of the model base 502 may be snap fit or press fit with each other. In more detail, one of the engagement features 506, 508 may include one or more receptacles and the other of the engagement features 508 may include one or more posts configured to be snap fit or press fit into the receptacles. For example, the model insert 504 may include posts 520 configured to be received into receptacles 522 of the model base 502. The posts 520 may be integrated into a carriage 506a of the model insert 504, and the receptacles may be integrated into a track 508a of the model base 502. In some embodiments, the posts 520 may extend outward from the carriage 506a. Further, it should be appreciated that in some embodiments, the model insert 504 may include the receptacles 522 and the model base 502 includes the posts 520. In alternative embodiments, the model insert 504 may include the track 508a, and the model base 502 may include the carriage 506a.

With further reference to FIGS. 5A and 5B, in some embodiments, the model inserts 504 may optionally include one or more tubes 524 integrated into the model insert 504. The tubes 524 may be used to simulate blood vessels or airways, and may carry pressure, fluid or gas through the model inserts 504. Using the tubes 524, the model inserts 504 may be used to simulate blood perfusion and/or to simulate air flow into tissue (e.g., as in the lungs). By way of example, in some embodiments, the track 508a of the model base 502 may be connected to one or more external fluid lines and/or gas or air lines (e.g., via compressed air lines or pneumatic lines) that are connected to a fluid and/or gas source for delivering fluid (e.g., simulated blood) and/or a gas (e.g., air or carbon dioxide) into the track 508a. The track 508a may have one or more inner channels 509 that function as gas lines and/or fluid lines and that are connected to the external gas and/or fluid sources and lines. The receptacles 522 of the track 508a may include ports 522a for inlet and/or outlet flow of the fluid and/or gas, the ports 522a being in fluid communication with the channels 509 of the track 508a. After fluid and/or gas flows into the ports 522a from the channels 509, the fluid and/or gas can flow through the posts 520 of the model insert 504 and be carried into the tubes 524 of the model insert 504. In some embodiments, the channels 509, the ports 522a, the tubes 524, and/or the posts 520 may have one-way valves to facilitate flow and prevent backflow. Some one-way valves may be one-way inlet valves that carry fluid and/or gas into the tubes 524 of the model insert 504 from a fluid and/or gas line. Other one-way valves may be one-way outlet valves that remove the fluid and/or gas from the tubes 524 of the model insert 504 and carry the fluid and/or gas out of the system through a fluid and/or gas line. A plurality of fluid and/or gas lines may be provided to transfer the fluid and/or gas into and out of the tubes 524 via the ports 522a, and may include inlet lines flowing fluid and/or gas into the model inserts 504 and separate outlet lines removing fluid and/or gas from the model inserts 504. The tubes 524 may form a circulatory path for the fluid and/or gas flow through the model inserts 504, with one or more inlet ports 522a providing flow into the tubes 524 and one or more outlet ports 522a providing flow out of the tubes 524. The channels 509 and the tubes 524 may be made of a flexible, semi-rigid, or rigid material, and may be made out of, for example, rubber or plastic. The inner channels 509 of the track 508a may include channels for inlet flow into the model inserts 504 and channels for outlet flow from the model inserts 504. In some embodiments, the inner channels 509 of the track 508a may have separate chambers or compartments to separately flow gas or a fluid. In some embodiments where the track 508a has multiple inner channels 509, some channels may be used as gas lines and other tubes being used as fluid lines. The channels 509 of the track 508a may be connected to a pressure control system that regulates the amount of fluid, gas, and/or pressure through the ports 522a. In some embodiments, the system may maintain a constant pressure within the model inserts 504 and the track 508a. In other embodiments, the system may have a varying pressure to create a pulsatile motion in the model inserts 504. In various embodiments, the pressure control system may be controlled to provide substantially equal amounts of fluid, gas, and/or pressure through the ports 522a, or may controlled to provide differing amounts of fluid, gas, and/or pressure through the ports 522a, or to provide substantially equal volumes through some ports 522a and differing volumes through other ports 522a. In some embodiments, differing tubes 524 of the same model insert 504 or of differing model inserts 504 may have different diameters from each other to provide varied flow. Similarly, different ports 522a of the same model insert 504 or of different model inserts 504 may have different diameters to provide variable flow.

As another example, in some embodiments, the carriage 506a itself may have one or more inner channels running along the length of the carriage 506a such that the carriage 506a is directly connected to external fluid lines and/or gas lines. The channels are in fluid communication with the tubes 524 of the model insert 504. Optionally, the tubes 524 may extend into the inner channels of the carriage 506a. The carriage 506a may extend along a portion or along an entire length of the model insert 504. In addition, the inner channels of the carriage 506a may extend along a portion or along the entire length of the carriage 506a. It should be appreciated that gas lines and/or fluid lines may be used with any of the surgical training systems described herein. For example, the carriages 106a, 206a, 206″, and 306 may have inner channels connected to a fluid and/or gas line, and may optionally contain one or more hollow inner tubes. The model inserts 104, 304 may optionally then contain the tubes 524. Further, the carriage 206a′ may have inner channels and hollow inner tubes. The connectors 112, 212, 212′ may also contain passages connecting the inner channels of the carriages 106a, 206a, 206a′, 206″, and 306 and/or the hollow inner tubes to the tubes 524.

In some embodiments, the tubes 524 may be electrically charged by an electrically conductive line running through the tubes 524. The electrically conductive line may be connected to an electrical power source, such as a current or voltage source (e.g., via line 526 shown in FIG. 5B). This may allow the surgeon to practice avoiding structures during training. When a surgical instrument having an electrically conductive end effector contacts the tubes 524 containing an electrically conductive line, there may be a resistance change or a closing of an electrical circuit. This change can be used to trigger an audible response (e.g., a buzzing sound) and/or visual response (e.g., color light up on an LED connected to the tubes 524, or on an external display). The audible and/or visual response may indicate an undesired action to the surgeon.

FIGS. 6A-6C illustrate a surgical training system 600 according to some embodiments. The surgical training system 600 may be an example of the surgical training systems described above with an anatomical shape. The embodiments of FIGS. 6A-6C are in the form of an abdominal cavity with a model base 602, model inserts 604, and depicted engagement features 608 of the model base 602. In the embodiments of FIGS. 6A-6C, some of the engagement features 608 are in the form tracks 608a, but are not limited thereto or thereby, and may have the form of the other engagement features described herein. FIG. 6A depicts the model base 602 with the tracks 608a exposed and with the model inserts 604 not installed. FIG. 6A further shows additional engagement features 608 in the form of openings 608b for placement of inguinal hernia model inserts 604a (the inguinal hernia model inserts are depicted in FIG. 6B). The openings 608b have a shape configured to receive the inguinal hernia model inserts 604a. The inguinal hernia model inserts 604a may be pressed into engagement with the openings 608b. In some embodiments, the openings 608b and the hernia model inserts 604a may have an interference fit when connected. Additionally or alternatively, the openings 608b and/or the hernia model inserts 604a may have additional retention features for engaging with each other, such as, for example, snaps, clips, protrusions, slots, receptacles, and the like. FIG. 6B depicts the model base 602 with model inserts 604 installed, including inguinal hernia model inserts 604a, a bladder 604b, large intestines 604c, small intestines 604d, stomach 604e, and liver/gallbladder 604f. FIG. 6C depicts a side view of the model base 602. As shown in FIG. 6C, the model base 102 may include one or more lower portions 602a, one or more side portions 602b, and/or one or more upper portions 602c. The lower portions 602a may be located below the model inserts 604. The side portions 602b may extend upwardly from the lower portions 602a, may optionally cover the lower portions 602a, and may optionally define one or more cavities where model inserts 604 are placed. The upper portion 602c may cover the lower portions 602a and/or the side portions 602b. In some embodiments, the side portions 602b and/or the upper portions 602c may be removable from the lower portion 602a. In some embodiments, the upper portions 602c may form a removable cover. For training open surgical techniques, the upper portions 602c may be removed and training conducted using the lower portion 602a and/or side portions 602b. Further, the lower portions 602a, side portions 602b, and/or the upper portions 602c may define one or more cavities for placement of the model inserts 604 therein. In some embodiments, the model base 102 may have a plurality of cavities separated by interior walls, for example, two, three, four, or more cavities. In some embodiments, the model base 102 may include only the lower portions 102a, only include the side portions 102b, only include the upper portions 102c, or any combination thereof. In the embodiments in FIGS. 6A-6C, both the lower portion 602a and the side portions 602b contain engagement features 608 (e.g., tracks 608a and openings 608b) for receiving the model inserts 604. The tracks 608a and openings 608b in the side portions 602b enable the model inserts 604 to be positioned above the lower potion 602a. In some embodiments, the tracks in the side portions 602b may allow connected model inserts 604 to be suspended (e.g., hanging) from the side portions 602b.

FIGS. 6D-6E illustrate a surgical training system 600′ according to some embodiments. The surgical training system 600′ of FIGS. 6D-6E is similar to the surgical training system 600 depicted in FIGS. 6A-6C, but also includes engagement features 608 in the upper portion 602c. The engagement features 608 are in the form tracks 608a, but are not limited thereto or thereby, and may have the form of the other engagement features described herein. The tracks 608a in the upper portion 602c enable installed model inserts 604a to be positioned above the lower portion 602a. In some embodiments, the tracks in the upper portion 602c may allow connected model inserts 604 to be suspending (e.g., hanging) from the upper portion 602c.

FIG. 7 illustrate a surgical training system 700 according to some embodiments. The surgical training system 700 of FIG. 7 is a human chest cavity model, and includes a model base 702 having engagement features 708 for connecting to model inserts. The engagement features 708 are in the form of tracks 708a. The model base includes a lower portion 702a that will be below located below model inserts when coupled, and upper portions 702c that will be above the model inserts when coupled.

In the surgical training systems described herein, the engagement features may be arranged in the model base and the model inserts to further aid in training using minimally invasive systems with laparoscopic or robotically assisted tools. To provide a realistic training experience, the engagement features may be located so that they do not impede accessing the model inserts. For example, one or more of the lower portions, side portions, or upper portions of the model base may be penetrated in regions that are spaced apart from the engagement features for tool access. The model base may include preformed openings (e.g., preformed port locations, natural orifice access locations, etc.) for tool access and/or openings in the model base may be formed by incisions during training for tool access.

Using the surgical training systems disclosed herein, minimally invasive instruments may be inserted into the model base and positioned near model inserts having anatomical features of interest. Such instruments may include an endoscope, an ablation device, a biopsy tool, a cutting tool, a vessel sealer, a surgical stapler, an ultrasound probe, and/or the like. The minimally invasive surgical instruments have shafts that are optionally flexible, semi-rigid or rigid. Navigation of the instruments can be manual, automatic under computer control, or a combination of manual with computer assistance.

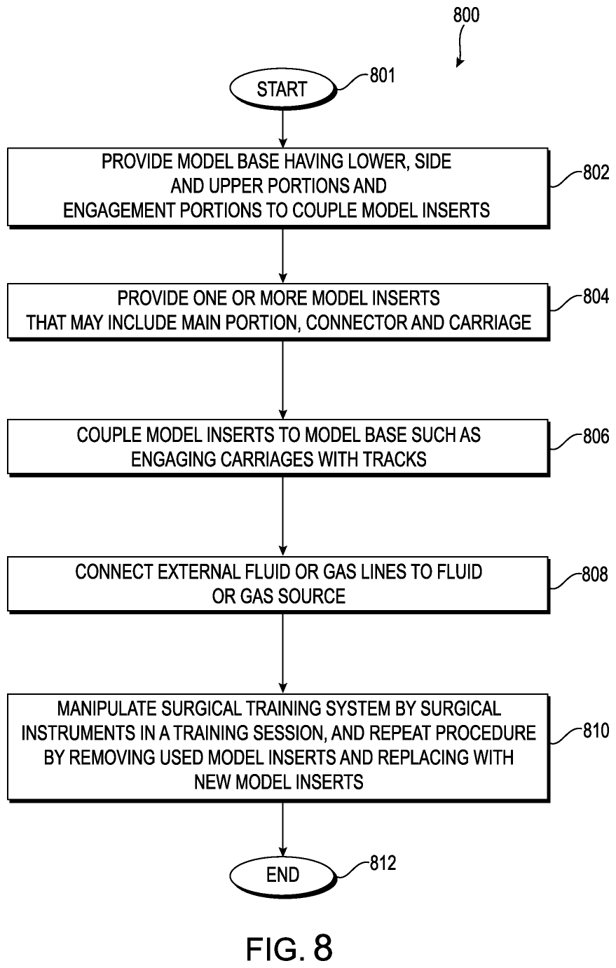

FIG. 8 is a flowchart illustrating a method for operating a surgical training system according to some embodiments and illustrated generally at 800. The surgical training system may be any of the surgical training systems disclosed herein. The process starts 801 and at a process 802, a model base is provided, which may include one or more lower portions, side portions, and upper portions as described above, or the model bases described further below. The model base may include respective engagement portions for coupling to one or more model inserts, and the engagement portions of the model base may be located in any of the lower portions, side portions, and upper portions. By way of example, the engagement portions of the model base may include one or more tracks. At a process 804, one or more model inserts are provided. Some of the model inserts may include a main portion, a connector, and a carriage. The carriage is configured to be releasably coupled to one or more of the tracks of the model base via sliding engagement. Other model inserts may include a main portion, a connector, and a retention member. The connector and/or the retention member are configured to be releasably coupled to one or more of the tracks of the model base via a pressing engagement. Each of the model inserts may be preassembled prior to operating the surgical training system, or the model inserts may be assembled at the time of training. At a process 806, the model inserts are coupled to the model base. Model inserts having a carriage are coupled by engaging the carriages of the model inserts with the tracks of the model base. The model inserts may be connected to the model base by sliding the carriages into engagement with the respective tracks of the model base. For connection to upper portions of the model base, the model inserts may be hanging or suspended from the tracks of the upper portions of the model base. Model inserts having the retention members may be coupled by pressing engagement with the respective tracks of the model base. At process 808, optionally, external fluid and/or gas lines that are connected to a fluid or gas source may be connected to the track or the carriage. The fluid or gas source may be used to provide pressure, fluid or gas through the model inserts. In addition, optionally, ground wires of the model inserts may be connected to an electrical current source as a return path for energy instruments. At process 810, the surgical training system may be manipulated by surgical instruments in a training session. Optionally, used model inserts are removed from the surgical training system and are replaced with new model inserts for repeated practice of the same procedure. The process ends at 812.

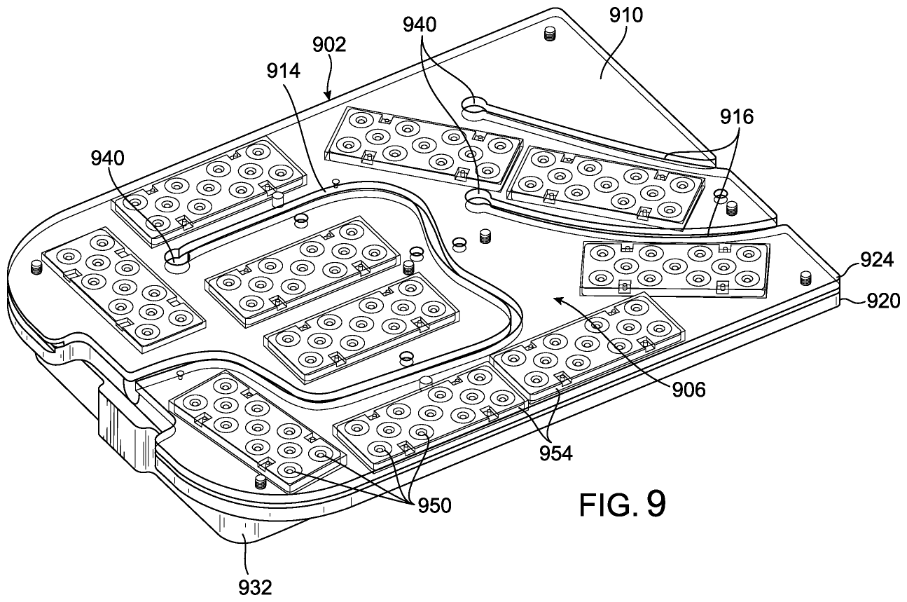

Referring now to FIG. 9, there is illustrated another embodiment of the model base 902 having at least one channel 906 therein, the channel 906 having an opening outwardly to a top surface 910 of the model base 902. In the depicted embodiment, the at least one channel 906 has a serpentine shape, and in this example, includes a generally U-shaped channel 914 and two separately substantially parallel curved channels 916 that extend toward a bottom section of the U-shaped channel. Other embodiments may have channels 906 with different shapes to accommodate various model inserts. The model base 902 may have or removably couple to a model insert such as the model insert 104 described in FIG. 1A and described relative to FIGS. 1A-7 that is removably coupled to the top surface 910 of the model base. This model insert 104 as described before may include tissue for surgical training, such as the organ portion 105a and connective tissue portion 105b described in FIG. 1A, and a plurality of connectors coupled to the tissue and slidably received within the at least one channel 906 such as the carriage 106 described in FIG. 1A that includes the elongated connector stem section 112 such as shown in FIG. 1C. Different connectors are described relative to FIGS. 1A-7.

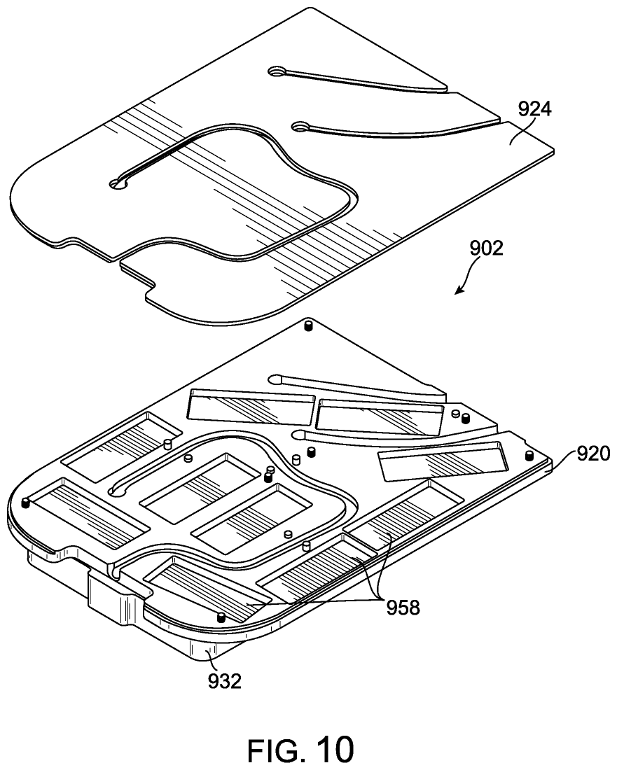

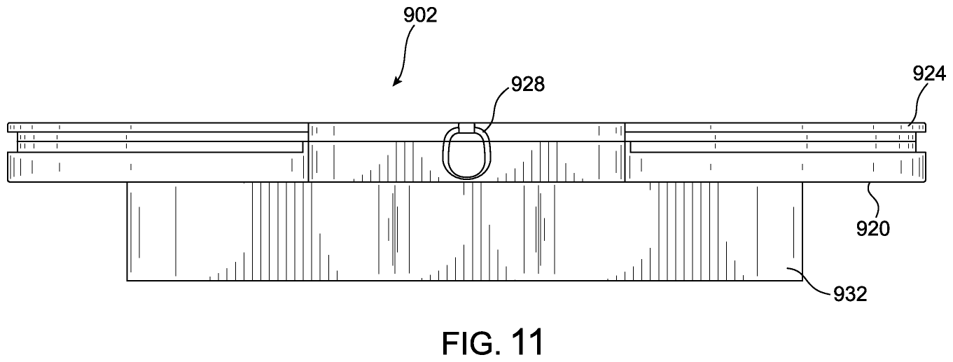

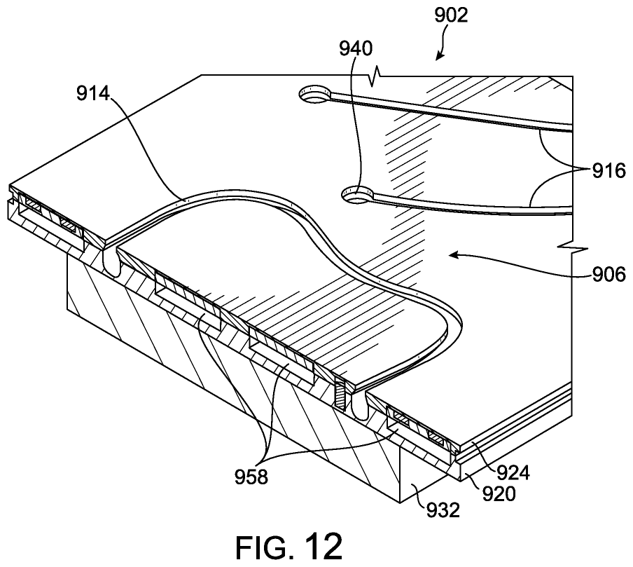

In this example, the model base 902 includes a lower layer 920 and an upper layer 924 coupled thereto, and as shown and FIGS. 10-12, wherein the upper layer defines a restriction 928 for at least one channel 906. When the model insert 104 is coupled to the channel, the model insert 104 extends through at least a portion of the upper layer 924. The restriction 928 hinders or prevents model inserts 104 from being vertically removed from the channel 906 and the model base 902 once coupled. In some embodiments, the restriction 928 may be in in the form of a semicircle shaped cutout as viewed from a cross-section of the upper layer 924 (see FIG. 11). In some embodiments, the channel 906 may have about 25% of the channel volume included in the upper layer 924 forming a semicircle upper element with about 75% of the channel included on the lower layer 920 forming a semicircle bottom element. In other embodiments, the upper layer 924 and the lower layer 920 may form different percentages of the channel volume, such as approximately 20% in the upper layer 924 with 80% in the lower layer 920, or 30% in the upper layer 924 with approximately 70% in the lower layer, or 40% in the upper layer 924 with 60% in the lower layer, or 50% in the upper layer 924 with 50% in the lower layer. The carriage 106 formed as a linear slider mechanisms in the example as described relative to FIG. 1A and other drawing figures holds the tissue 105a, 105b and may slide between the lower layer 920 and upper layer 924 coupled thereto.

As noted before, the tissue 105a, 105b for surgical training may comprise harvested tissue or may comprise synthetic tissue. When harvested tissue is used for surgical training, many of the fluids and artificial blood or other fluids from the harvested animal tissue may fill the channels and pass between the lower layer 920 and upper layer 924. The two portions as the lower layer 920 and upper layer 924 may be separated and cleaned such as placing them in cleaning tub or washing via spray.

The lower layer 920 may include a bottom backing 932 (FIG. 11) that can be formed from aluminum, plastic, or other material. The upper layer 924 may be formed from clear or a colored plastic and the lower layer 920 may be formed from plastic, metal, or similar material. In an example, both the lower layer 920 and upper layer 924 are formed from machined plastic components. The lower layer 920 and upper layer 924 may be held together by magnets, posts, threaded members, screws other attachment mechanisms. The model base 902 includes its lower layer 920 that operates as a tissue track as explained with reference to FIGS. 1A-7 with the upper layer 924 as a plastic cover, in an example, that may be removed to facilitate cleaning.

As illustrated in FIG. 9, the end of each channel 906 that forms part of the tissue track may have an enlarged bulbous portion 940 at the end of the channel 906 that receives a model insert 104 and its connectors, such as the carriage 106 and its associated elongate connector stem section 112 coupled to the tissue 105a, 105b and aids in slidably receiving the model insert 104 and connectors 112 within the channel. These connectors may be formed as a plurality of hooks 112 shown in FIG. 1E and a compressible elongate member 106′ received within the hooks. At least one tube 524 (FIGS. 5A and 5B) may be carried by the model base 902 as described above. Also, at least one electrical conductor 526 (FIG. 5B) or other electrical lead 316 (FIG. 3) may be carried by the model base 902. At least one sensor, such as a force sensor shown at 314 in FIG. 3, may be connected to the electrical lead 316 to provide feedback to the user. For example, an electrical conductor or lead 316 could be connected to a force sensor 314 as in FIG. 3 and incorporated with a tube 524 as shown in FIGS. 5A and 5B, carrying blood such that when a surgical instrument engages and cuts the tube during training, artificial blood may flow and the sensor may indicate the amount of force that had been exerted by carrying an electric current indicative of the force exerted by the surgical tool. An audible tone may be generated that may vary depending on the amount of force and damage to the tube that acts as a blood vessel.

A plurality of permanent magnets 950 may be configured to retain additional tissue for surgical training. In the example as shown in FIG. 9, magnet holders 954 retain a number of permanent magnets 950. The magnet holders 954 are positioned within the lower layer 920 of the model base 902 and received within cut-outs 958 (FIG. 10) in the lower layer 920 that are configured to receive the magnet holders. The magnet holders 954 may be removably coupled to the model base 902. In this example, the magnet holders 954 are rectangular configured, and in the example of FIG. 9, ten magnet holders are positioned between and among the channels 906, however, other shapes and numbers of magnet holders are possible. A model insert 104 may include tissue such as the organ portion 105a and connective tissue portion 105b described above for surgical training. A magnetic metal plate, for example, may hold the tissue 105a, 105b as part of the model insert 104 and may be manipulated on the model base 902 and positioned where desired for training. In this example, each magnet holder 954 includes 11 circular configured permanent magnets 950.

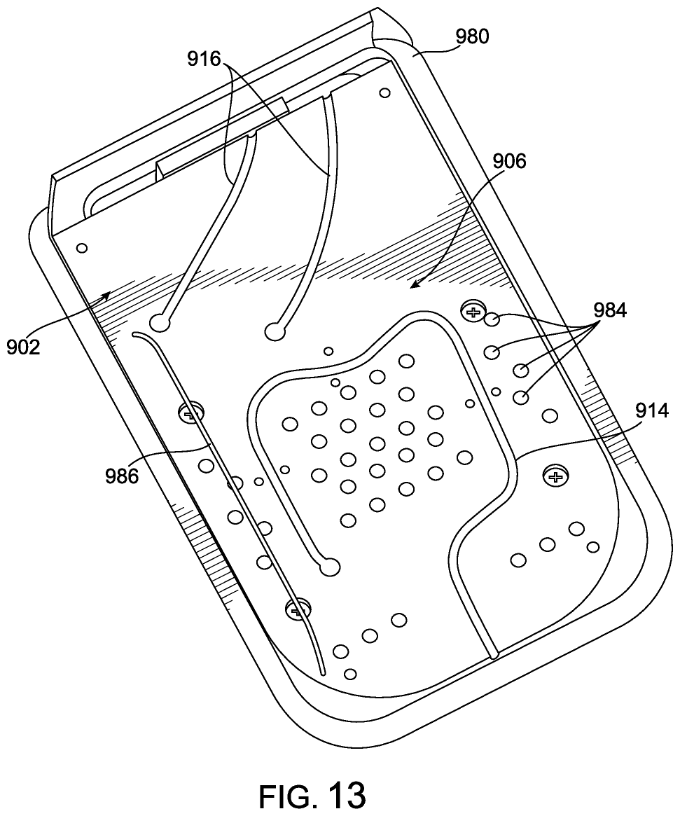

Referring now to FIG. 13, there is illustrated another example of the model base 902 received within an abdominal model 980, such as a carrier, that may be positioned on an operating table or other support structure as part of an operating area for use as a surgical training system 100. In this example, instead of using magnet holders 954 to hold permanent magnets 950, magnets may be received within circular openings 984 as shown in FIG. 13 and positioned near the channels 914, 916. In this example, connectors 986 that may be coupled to tissue are shown stored on the left-hand side of the model base 902 in FIG. 13 and may be configured to clip to harvested or synthetic tissue and be slidably received within at least one channel 906. These connectors 986 may be connected to each other and form a string where the connectors are slidably received within a channel 906 and hold a model insert 104, such as shown in FIG. 1A, that includes the tissue 105a, 105b for surgical training in a desired position.

The surgical training system 100 may be used, for example, with remotely operated, computer-assisted or teleoperated surgical systems, such as those described in, for example, U.S. Pat. No. 9,358,074 (filed May 31, 2013) to Schena et al., entitled “Multi-Port Surgical Robotic System Architecture;” U.S. Pat. No. 9,295,524 (filed May 31, 2013) to Schena et al., entitled “Redundant Axis and Degree of Freedom for Hardware-Constrained Remote Center Robotic Manipulator;” and U.S. Pat. No. 8,852,208 (filed Aug. 12, 2010) to Gomez et al., entitled “Surgical System Instrument Mounting;” each of which is hereby incorporated by reference in its entirety.

Further, the real-tissue surgical trailing system 100 described herein may be used, for example, with a da Vinci® Surgical System, such as the da Vinci X® Surgical System or the da Vinci Xi® Surgical System, both with or without Single-Site® single orifice surgery technology, all commercialized by Intuitive Surgical, Inc., of Sunnyvale, Calif. Although various embodiments described herein are discussed in connection with a manipulating system of a teleoperated surgical system, the present disclosure is not limited to use with a teleoperated surgical system. Various embodiments described herein can optionally be used in conjunction with hand held instruments, such as laparoscopic tools for real-time surgical training with a harvested porcine tissue cassette.

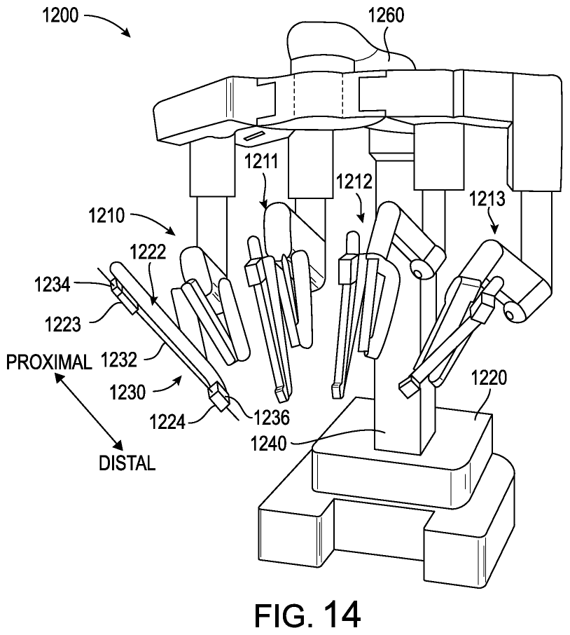

As discussed above, in accordance with various embodiments, surgical tools or instruments of the present disclosure are configured for use in teleoperated, computer-assisted surgical systems employing robotic technology (sometimes referred to as robotic surgical systems). Referring now to FIG. 14, an embodiment of a manipulator system 1200 of a computer-assisted surgical system, to which surgical instruments are configured to be mounted for use, is shown. Such a surgical system may further include a user control system, such as a surgeon console (not shown) for receiving input from a user to control instruments coupled to the manipulator system 1200, as well as an auxiliary system, such as auxiliary systems associated with the DA VINCI X® and DA VINCI XI®, Da Vinci SP.

As shown in the embodiment of FIG. 14, a manipulator system 1200 includes a base 1220, a main column 1240, and a main boom 1260 connected to main column 1240. Manipulator system 1200 also includes a plurality of manipulator arms 1210, 1211, 1212, 1213, which are each connected to main boom 1260. Manipulator arms 1210, 1211, 1212, 1213 each include an instrument mount portion 1222 to which an instrument 1230 may be mounted, which is illustrated as being attached to manipulator arm 1210.

Instrument mount portion 1222 may include a drive assembly 1223 and a cannula mount 1224, with a transmission mechanism 1234 of the instrument 1230 connecting with the drive assembly 1223, according to an embodiment. Cannula mount 1224 is configured to hold a cannula 1236 through which a shaft 1232 of instrument 1230 may extend to a surgery site during a surgical procedure. Drive assembly 1223 contains a variety of drive and other mechanisms that are controlled to respond to input commands at the surgeon console and transmit forces to the transmission mechanism 1234 to actuate the instrument 1230. Although the embodiment of FIG. 14 shows an instrument 1230 attached to only manipulator arm 1210 for ease of viewing, an instrument may be attached to any and each of manipulator arms 1210, 1211, 1212, 1213.

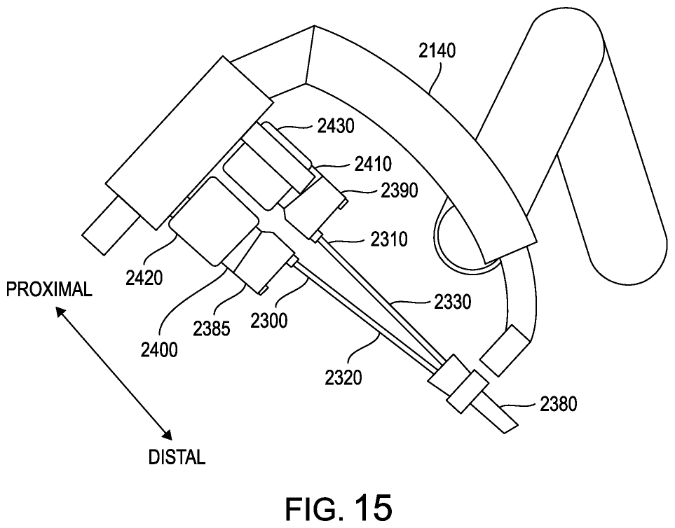

Other configurations of surgical systems, such as surgical systems configured for single-port surgery, are also contemplated. For example, with reference now to FIG. 15, a portion of an embodiment of a manipulator arm 2140 of a manipulator system with two surgical instruments 2300, 2310 in an installed position is shown. The surgical instruments 2300, 2310 can generally correspond to different instruments used for real-time tissue training using the harvested porcine tissue cassette. For example, the embodiments described herein may be used with a DA VINCI SP® Surgical System, commercialized by Intuitive Surgical, Inc. of Sunnyvale, Calif. The schematic illustration of FIG. 15 depicts only two surgical instruments for simplicity, but more than two surgical instruments may be mounted in an installed position at a manipulator system as those having ordinary skill in the art are familiar. Each surgical instrument 2300, 2310 includes a shaft 2320, 2330 having at a distal end a moveable end effector or an endoscope, camera, or other sensing device, and may or may not include a wrist mechanism (not shown) to control the movement of the distal end.

In the embodiment of FIG. 15, the distal end portions of the surgical instruments 2300, 2310 are received through a single port structure 2380 to be introduced into the harvested porcine tissue through the opening of the mouth and associated upper and lower jaws and into communication with the oropharynx region. As shown, the port structure includes a cannula and an instrument entry guide inserted into the cannula. Individual instruments are inserted into the entry guide to reach a surgical site corresponding to the oropharynx region of the porcine tissue that simulates the oropharynx region of the human body.

Other configurations of manipulator systems that can be used in conjunction with the present disclosure can use several individual manipulator arms. In addition, individual manipulator arms may include a single instrument or a plurality of instruments. Further, as discussed above, an instrument may be a surgical instrument with an end effector or may be a camera instrument or other sensing instrument utilized during a surgical procedure to provide information, (e.g., visualization, electrophysiological activity, pressure, fluid flow, and/or other sensed data) of a remote surgical site.

Transmission mechanisms 2385, 2390 are disposed at a proximal end of each shaft 2320, 2330 and connect through a sterile adaptor 2400, 2410 with drive assemblies 2420, 2430, which contain a variety of internal mechanisms (not shown) that are controlled by a controller (e.g., at a control cart of a surgical system) to respond to input commands at a surgeon side console of a surgical system to transmit forces to the force transmission mechanisms 2385, 2390 to actuate surgical instruments 2300, 2310.

The embodiments described herein are not limited to the embodiments of FIGS. 14 and 15, and various other teleoperated, computer-assisted surgical system configurations may be used with the embodiments described herein. The diameter or diameters of an instrument shaft and end effector are generally selected according to the size of the cannula with which the instrument will be used and depending on the surgical procedures being performed.

One or more elements in embodiments of the present disclosure may be implemented in software to execute on a processor of a computer system such as a control system. When implemented in software, the elements of the embodiments of the present disclosure are essentially the code segments to perform the necessary tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit; a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc.

This description and the accompanying drawings that illustrate various embodiments should not be taken as limiting. Various mechanical, compositional, structural, electrical, and operational changes may be made without departing from the scope of this description and the invention as claimed, including equivalents. In some instances, well-known structures and techniques have not been shown or described in detail so as not to obscure the disclosure. Like numbers in two or more figures represent the same or similar elements. Furthermore, elements and their associated features that are described in detail with reference to one embodiment may, whenever practical, be included in other embodiments in which they are not specifically shown or described. For example, if an element is described in detail with reference to one embodiment and is not described with reference to another embodiment, the element may nevertheless be claimed as included in the other embodiment.

For the purposes of this specification and appended claims, unless otherwise indicated, all numbers expressing quantities, percentages, or proportions, and other numerical values used in the specification and claims, are to be understood as being modified in all instances by the term “about,” to the extent they are not already so modified. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Further, this description's terminology is not intended to limit the invention. For example, spatially relative terms—such as “beneath,” “below,” “lower,” “above,” “upper,” “proximal,” “distal,” and the like, may be used to describe one element's or feature's relationship to another element or feature as illustrated in the figures. These spatially relative terms are intended to encompass different positions (i.e., locations) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the example term “below” can encompass both positions and orientations of above and below. A device may be otherwise oriented (rotated 90 degrees or at other orientations) and the spatially relative descriptors used herein interpreted accordingly.

It is to be understood that the particular examples and embodiments set forth herein are non-limiting, and modifications to structure, dimensions, materials, and methodologies may be made without departing from the scope of the present teachings.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A surgical training system comprising:
a model base having at least one channel therein, a top surface, and an opposite bottom surface, wherein the at least one channel has an opening directed outwardly to the top surface; and
a model insert removably coupled to the channel of the model base, the model insert comprising tissue for surgical training and a plurality of connectors coupled to the tissue and slidably received within the at least one channel.

2. The surgical training system of claim 1,
wherein the model base comprises a lower layer and an upper layer coupled thereto,
wherein the upper layer defines a restriction for the at least one channel, and
wherein the restriction prevents the model insert from being removed from the opening directed outwardly to the top surface of the model base.

3. The surgical training system of claim 1, wherein the plurality of connectors comprises a plurality of hooks and a compressible elongate member received within the hooks.

4. The surgical training system of claim 1, wherein the tissue for surgical training comprises real tissue.

5. The surgical training system of claim 1, wherein the tissue for surgical training comprises synthetic tissue.

6. The surgical training system of claim 1, wherein the model base comprises a plurality of permanent magnets and configured to retain additional tissue for surgical training.

7. The surgical training system of claim 1, further comprising at least one tube carried by the model base.

8. The surgical training system of claim 1, further comprising at least one electrical conductor carried by the model base.

9. The surgical training system of claim 1, further comprising at least one sensor carried by the model base.

10. The surgical training system of claim 1, further comprising at least one force sensor carried by the model base.

11. A surgical training system comprising:
a model base having at least one channel therein and opening outwardly to a top surface, the model base comprising a lower layer and an upper layer coupled thereto and wherein the upper layer defines a restriction for the at least one channel; and
a model insert removably coupled to the channel of the model base and extending through at least a portion of the upper layer, the model insert comprising tissue for surgical training and a plurality of connectors coupled to the tissue and slidably received within the at least one channel.

12. The surgical training system of claim 1, wherein the plurality of connectors comprises a plurality of hooks and a compressible elongate member received within the hooks.

13. The surgical training system of claim 1, wherein the model base comprises a plurality of permanent magnets and configured to retain additional tissue for surgical training.

14. The surgical training system of claim 1, further comprising at least one of a tube carried by the model base, an electrical conductor carried by the model base, a sensor carried by the model base, and a force sensor carried by the model base.

15. A surgical training method using a model base having at least one channel therein and opening outwardly to a top surface of the model base, the method comprising:
coupling a model insert to the top surface of the model base, the model insert comprising tissue for surgical training and a plurality of connectors coupled to the tissue and slidably received within the at least one channel.

16. The method of claim 15, wherein the model base comprises a lower layer and an upper layer coupled thereto,
wherein the upper layer defines a restriction for the at least one channel, and
wherein the restriction prevents the model insert from being removed from the opening directed outwardly to the top surface of the model base.

17. The method of claim 15, wherein the plurality of connectors comprises a plurality of hooks and a compressible elongate member received within the hooks.

18. The method of claim 15, wherein the tissue for surgical training comprises at least one of harvested tissue and synthetic tissue.

19. The method of claim 15, further comprising using a plurality of permanent magnets coupled to the model base to retain additional tissue for surgical training.

20. The method of claim 15, further comprising using at least one of a tube carried by the model base, an electrical conductor carried by the model base, a sensor carried by the model base, and a force sensor carried by the model base.
